(19) United States
(12) Patent Application Publication
(10) Pub. No.: US 2003/0133611 A1
(43) Pub. Date: Jul. 17, 2003

(54) Method and device for determining an object in an image

(75) Inventors: Gustavo Deco, Neubiberg (DE); Bernd Schuermann, Haimhausen (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/276,069

(22) PCT Filed: May 7, 2001
(86) PCT No.: PCT/DE01/01744

(30) Foreign Application Priority Data
May 9, 2000 (DE) 100 22 480.6

(51) Int. Cl. G06K 9/46; G06K 9/66

(52) U.S. Cl. 382/190

(57) ABSTRACT

For determining an object in an image, hierarchical partial areas and sub-partial areas are selected, which are recorded with different resolution on each hierarchical level and which are compared with features of the object to be identified. If the object is identified with a sufficient level of certainty, the object to be identified is output as an identified object. If this is not the case, an additional sub-partial area of the current partial area is selected, and information with an, in turn, increased local resolution is detected from said sub-partial area.

The invention relates to a method for determining an object in an image, and to arrangements for determining an object in an image.

A method such as this and an arrangement such as this are known from [1].

In the procedure which is known from [1], information in in each case one subregion of an image is recorded from the image which is recorded by means of a camera and which contains an object to be identified. A feature extraction process is carried out for the recorded information, and the extracted features from the subregion are compared by means of a known pattern recognition method with previously extracted features which describe the object to be identified.

If the similarity between the extracted features from the subregion and the predetermined features which describe the object to be identified are sufficiently high, then the method is ended and the identified object for which the extracted features have been formed is output as an identified object.

The method is carried out iteratively for different subregions of the image until the object has been identified or until a predetermined determination criterion is satisfied, for example a predetermined number of iterations or sufficiently accurate identification of the object to be identified.

One particular disadvantage of this procedure is the very high computation time requirement for determining an object in the image to be investigated. This is due in particular to the fact that all the subregions of the image are dealt with in the same way, that is to say the local resolution for all the subregions of the image is the same throughout the course of the method for object determination.

Furthermore, a so-called two-dimensional Gabor transformation in the form of a wavelet transformation is known from [2]. The two-dimensional Gabor transformations are basic functions which use local physical bandpass filters to achieve the theoretical optimum overall resolution in the space domain and in the frequency domain, that is to say in the one-dimensional space domain and in the two-dimensional frequency domain.

Further transformations are known from [3] and [4].

The invention is based on the problem of determining an object in an image, in which case the determination process can be carried out with a statistically reduced computation time requirement. Furthermore, the invention is based on the problem of training an arrangement with a learning capability such that the arrangement can be used in the course of determining an object in an image, so that this results in less computation time being required than in the case of the known procedure for determining the object in an image using the trained arrangement with a learning capability.

The problems are solved by the methods, the arrangements, the computer program element and the computer-legible storage medium having the features as claimed in the independent patent claims.

In a method for determining an object in an image, information is recorded from the image with a first local resolution. A first feature extraction process is carried out for the recorded information. At least one subregion in which the object could be located is selected from the image on the basis of the first feature extraction process. Information is also recorded with a second local resolution from the selected subregion. The second local resolution is higher than the first local resolution. A second feature extraction process is carried out for the information which has been recorded with the second local resolution, and a check is carried out to determine whether a predetermined criterion relating to the features extracted by means of the second feature extraction process is satisfied from the information. If the predetermined criterion is not satisfied, information from at least one subsubregion of the selected subregion is recorded iteratively, in each case with a higher local resolution, and a check is carried out to determine whether the information recorded with the respectively higher local resolution satisfies the predetermined criterion, until the predetermined criterion is satisfied, or a further subregion is selected from the image, and information from the further subregion is recorded with a second local resolution. Alternatively, the method can be ended.

The information may, for example, be brightness information and/or color information, which are/is associated with pixels of a digitized image, in the course of digital image processing.

The invention achieves a considerable saving in computation time in the course of determining an object in an image.

The invention is clearly based on the knowledge that, in the course of visual perception of a living being, a hierarchical procedure for perception of individual regions of different size with different local resolution will probably normally lead to the aim of identification of an object being sought.

The invention can clearly been seen in that subregions and subsubregions are selected hierarchically in order to determine an object in an image, are each recorded with a different resolution on each hierarchical level and, once a feature extraction process has been carried out, are compared with features of the object to be identified. If the object is identified with sufficient confidence, then the object to be identified is output as the identified object. However, if this is not the case, then, alternatively, the options are available of either selecting a further subsubregion in the current subregion or of recording information from this subsubregion with a further increase in the local resolution, or of selecting another subregion and once again investigating this for the object to be identified.

In a method for training an arrangement with a learning capability, which arrangement can be used for determining an object in an image, an image is recorded which contains an object to be determined. The position of the object to be identified within the image and the object itself are predetermined. A number of feature extraction processes are carried out for the object, in each case with a different local resolution. The arrangement with a learning capability is in each case trained for a different local resolution using the extracted features.

The [lacuna] in the invention can be implemented both by means of a computer program, that is to say in software, and by means of a specific electronic circuit, that is to say in hardware.

Preferred developments of the invention can be found in the dependent claims.

The further refinements relate both to the methods, the arrangements, the computer-legible storage medium and the computer program element.

As one predetermined criterion, it is possible to use the test as to whether the information recorded with the respective local resolution is sufficient in order to determine the object with sufficient accuracy.

The predetermined criterion may also be a predetermined number of iterations, that is to say a predetermined number of maximum iterations in each of which one subsubregion is selected and is investigated with an increased local resolution.

Furthermore, the predetermined criterion may be a predetermined number of subregions to be investigated or a maximum number of subsubregions to be investigated.

The feature extraction process can be carried out by means of a transformation, in each case using a different local resolution.

A wavelet transformation is preferably used as the transformation, preferably a two-dimensional Gabor transformation (2D Gabor transformation).

The use of the two-dimensional Gabor transformation results in the image information being coded in an optimum manner both in the space domain and in the spectral domain, that is to say an optimum compromise is achieved between the space domain coding and frequency domain coding in the course of reduction of redundant information.

Any transformation which satisfies in particular the following preconditions may be used as the transformation:

the aspect ratio of the elliptical Gaussian envelopes should be essentially 2:1;

the planar wave should have its propagation direction along the minor axis of the elliptical Gaussian envelopes;

furthermore, the half-amplitude bandwidth of the frequency response should cover approximately 1 to 1.5 octaves along the optimum direction.

Furthermore, the mean value of the transformation should have the value zero in order to ensure a reliable function basis for the wavelet transformation.

Alternatively, the transformations described in [3] and [4] may also be used.

The transformation may be carried out by means of a neural network or a number of neural networks, preferably means of a recurrent neural network.

The use of a neural network results in particular in a very fast transformation arrangement which can be matched to the respective object to be identified and/or to the correspondingly recorded image information.

In a further refinement of the invention, a number of subregions are determined in the image, with a probability in each case being determined for each subregion of the corresponding subregion containing the object to be identified. The iterative method is carried out for detailed areas in the sequence of correspondingly falling association probability of the object that is correspondingly to be determined.

This procedure achieves a further reduction in the computation time requirement since, from the statistical point of view, an optimum procedure is specified for determining the object to be identified.

In order to reduce the computation time requirement further, one development of the invention provides for the shape of a selected subregion to be essentially matched to the shape of the object to be determined.

In this way, in each case one subregion or else one subsubregion is investigated which intrinsically essentially corresponds to the object to be determined. This avoids investigating an image region in which the object to be determined is certainly not located, since the corresponding image region will then have a different shape in any case.

At least one neural network may be used as the arrangement with a learning capability.

The neurons of the neural network are preferably arranged topographically.

An exemplary embodiment of the invention will be explained in more detail in the following text and is illustrated in the figures, in which:

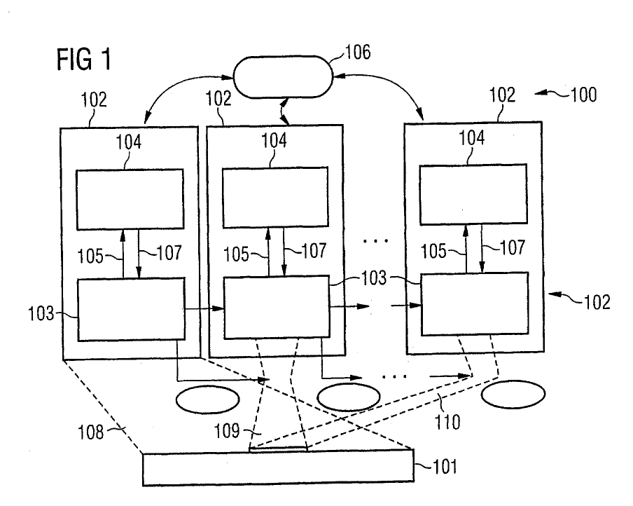

FIG. 1 shows a block diagram illustrating the architecture of the arrangement for determining the object according to one exemplary embodiment of the invention;

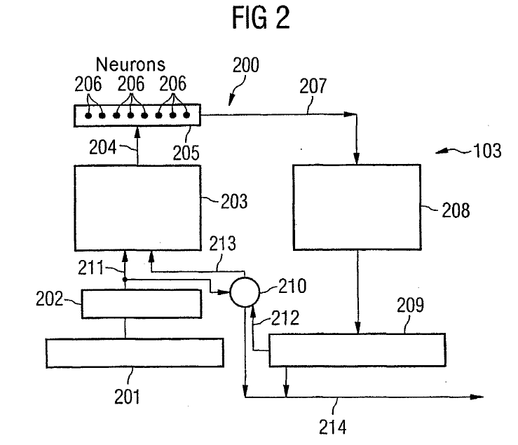

FIG. 2 shows a block diagram illustrating the detailed construction of the module for carrying out the two-dimensional Gabor transformation from FIG. 1 according to the exemplary embodiment of the invention;

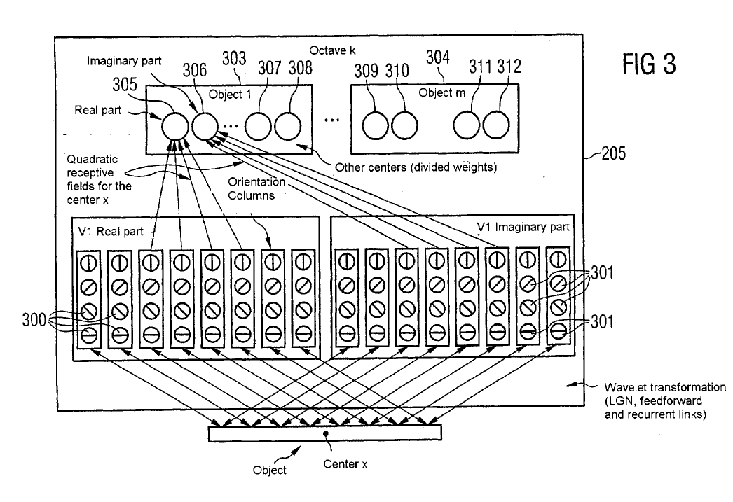

FIG. 3 shows a block diagram illustrating in detail the identification module from FIG. 1 according to the exemplary embodiment;

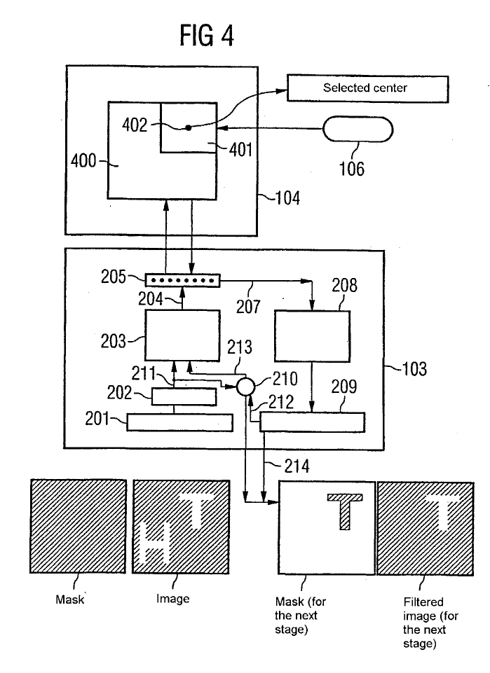

FIG. 4 shows a block diagram illustrating in detail the architecture of the arrangement for determining the object according to one exemplary embodiment of the invention, showing the process of determining a priority map;

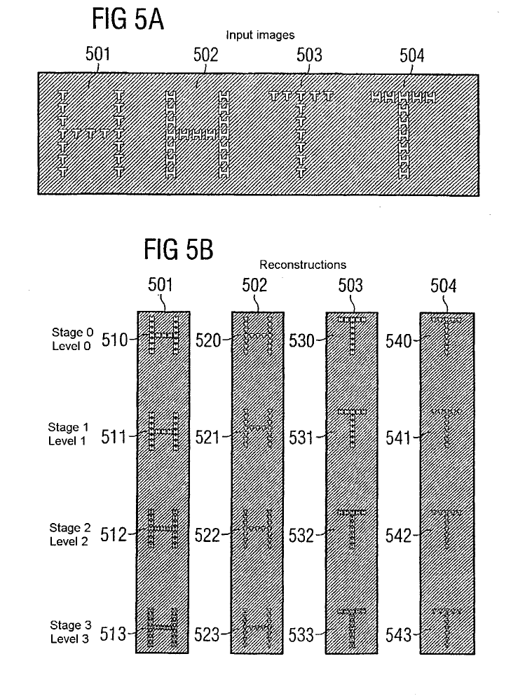

FIGS. 5a and 5b show sketches of an image with different objects, from which the object to be determined can be determined, with FIG. 5a showing the different recorded objects, and with the identification result having been determined for different local resolutions in FIG. 5b;

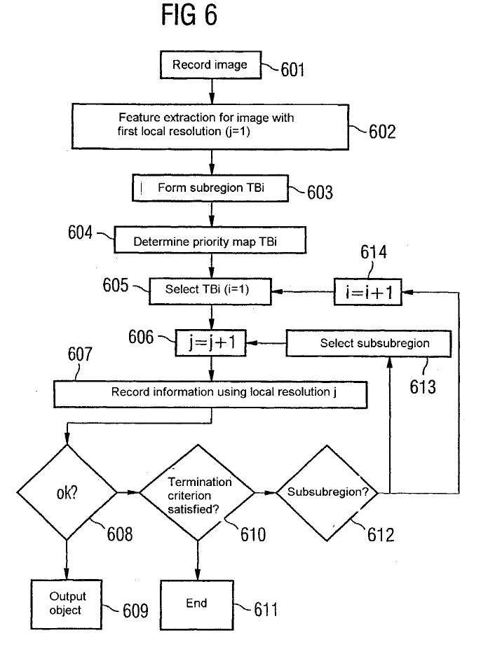

FIG. 6 shows a flowchart illustrating the individual steps of the method according to the exemplary embodiment of the invention.

FIG. 1 shows a sketch of an arrangement 100 by means of which the object to be determined is determined.

The arrangement 100 has a visual field 101.

Furthermore, a recording unit 102 is provided, by means of which information from the image can be recorded with different local resolution over the visual field 101.

The recording unit 102 has a feature extraction unit 103 and an identification unit 104.

FIG. 1 shows a large number of feature extraction units 103 in the recording unit 102, which each record information from the image with a different local resolution.

Extracted features from the recorded image information are in each case supplied from the feature extraction unit 103 to the identification module, that is to say to the identification unit 104, as a feature vector 105.

Pattern comparison of the feature vector 105 with a previously formed feature vector is carried out in the identification unit 104, which will be explained in more detail in the following text, in the manner which will be explained in more detail in the following text.

The identification result is supplied to a control unit 106, which decides which subregion or subsubregion of the image is selected (as will be explained in more detail in the following text), and with which local resolution the respective subregion or subsubregion will be investigated. The control unit 106 furthermore has a decision unit, in which a check is carried out to determine whether a predetermined criterion relating to the extracted features is satisfied.

Arrows 107 indicate symbolically that “switching” is carried out as a function of control signals from the control unit 106 between the individual identification units 104 for recording information in different recording regions 108, 109, 110, and in each case with different local resolutions.

The feature extracted unit 103, which is illustrated in detail in FIG. 2, will be explained in more detail in the following text.

If the two-dimensional Gabor wavelets are set up such that the frequency domain is arranged such that it is split logarithmically, then each recorded frequency is referred to as an octave. Each octave is also referred to as a local resolution.

Every unit which carries out wavelet transformation with a predetermined local resolution has an arrangement of neurons whose recording range corresponds to a two-dimension Gabor function and which are dependent on a specific orientation.

The output of the corresponding neuron is furthermore dependent on the predetermined local resolution, and is symmetrical. Every feature extraction unit 103 has a recurrent neural network 200, as is illustrated in FIG. 2.

The following text is based on the assumption of a digitized image 201 with n*n pixels (according to this exemplary embodiment, n=128, that is to say, according to the exemplary embodiment, the image has 16384 pixels).

Each pixel is associated with a brightness value Iᵢⱼ^{orig} between “0” (black) and “255” (white).

The brightness value Iᵢⱼ^{orig} in each case denotes the brightness value which is associated with one pixel, which pixel is located within the image 201 at the local coordinates identified by the indices i, j.

A mean brightness value DC is determined from the image 201, that is to say from the pixels which are located in the respective recording region,

$$DC = \frac{1}{{n}^{2}} {\sum }_{i = 1}^{n} {\sum }_{j = 1}^{n} {I}_{ij}^{orig} , \qquad ( 1 )$$

of the brightness values Iᵢⱼ^{orig} of the pixels of the image 201 which are located in the recording region, and the mean brightness value DC is subtracted from the brightness values Iᵢⱼ^{orig} of each pixel by a contrast correction unit 202.

This results in a set of brightness values which are contrast-invariant. The contrast-invariant description of the brightness values of the pixels in the recording region is formed using the following rule:

$${I}_{ij} = {I}_{ij}^{orig} - \frac{1}{{n}^{2}} {\sum }_{i = 1}^{n} {\sum }_{j = 1}^{n} {I}_{ij}^{orig} . \qquad ( 2 )$$

The DC-free brightness values are supplied to a neuron layer 203, whose neurons carry out an extraction of simple features.

The neurons in the neuron layer 203 have receptive fields, which carry out a two-dimensional Gabor transformation in accordance with the following rule:

$$Ψ ( x , y , {ω}_{0} , Θ ) = \frac{{ω}_{0}}{\sqrt{2 ΠΚ}} {ⅇ}^{- \frac{{ω}_{0}^{2}}{8 {Κ}^{2}} ( 4 \cdot {( x cos Θ + y sin Θ )}^{2} + {( - x sin Θ + y cos Θ )}^{2} )} \cdot \\ [ {ⅇ}^{ⅈ {ω}_{0} ( x cos Θ + y sin Θ )} - {ⅇ}^{- \frac{{Κ}^{2}}{2}} ] \qquad ( 3 )$$

where

ω₀ is a circular frequency in radians per length unit, and

Θ is the orientation direction of the wavelet in radians.

The Gabor wavelet is centered at

x=y=0 (4)

and is normalized by means of an L² norm such that:

<ψ, ω>=1. (2)

The constant K defines the frequency bandwidth.

According to this exemplary embodiment:

K=π (6)

is used, which corresponds to a frequency bandwidth of one octave.

A family of one discrete 2D Gabor wavelet G_{kpql}(x, y) can be formed by digitization of the frequencies, orientations and of the centers of the continuous wavelet function (3) using the following rule:

G_{kpql}(x, y)=a^{-k}ψ_{Θ}_{ₗ}(a^{-k}x−pb, a^{-k}y−qb), (7)

where

ψ_{Θ}_{ₗ}=ψ(x cos(lΘ₀)+y sin(lΘ₀),−x sin(lΘ₀)+y cos(lΘ₀)) (8)

and the basic wavelet:

$$Ψ ( x , y ) = \frac{1}{\sqrt{2 Π}} {ⅇ}^{- \frac{1}{8} ( 4 {x}^{2} + {y}^{2} )} \cdot [ {ⅇ}^{ⅈ KX} - {ⅇ}^{- \frac{{Κ}^{2}}{2}} ] . \qquad ( 9 )$$

According to this rule

$${Θ}_{0} = \frac{Π}{L}$$

is the step size of the respective angle rotation,

l is the index of the rotation corresponding to the preferred orientation

$${Θ}_{1} = \frac{1 Π}{L} ,$$

k is the respective octave, and

p and q are the positions of the center of the respective fields (cₓ=pba^{k} and c_{y}=qba^{k}).

For a given octave k, the maximum values of p and q are given by:

$$P = ⌊ \frac{n}{{ba}^{k}} ⌋ , \qquad ( 10 )$$

and

$$Q = ⌊ \frac{n}{{ba}^{k}} ⌋ , \qquad ( 11 )$$

where └x┘ denotes the largest integer number which is less than x.

In the following text, r_{kpql} denotes the activation of one neuron in the neuron layer 203.

The activation r_{kpql} is dependent on a specific local frequency, which [lacuna] by the octave k with respect to a preferred orientation, which [lacuna] by the rotation index l and with respect to a stimulus at the center, defined by the indices p and q, is dependent [lacuna].

The activation rkpql of the neuron in the respective neuron layer 203 is defined as the convolution of the corresponding receptive field and the image, that is to say the brightness values of the pixels, as a result of which the activation rkpql of a neuron is given by the following rule:

$${r}_{kpql} = ⟨ {G}_{kpql} , I ⟩ = {\sum }_{i = 1}^{n} {\sum }_{j = 1}^{n} {G}_{kpql} ( i , j ) \cdot {I}_{ij} \cdot {g}_{ij} , \qquad ( 12 )$$

where gᵢⱼ is a weight value for the pixel (i, j) of the recording unit with the corresponding local resolution k.

It should be noted that the activation r_{kpql} of a neuron is a complex number, for which reason two neurons are used for coding one brightness value Iᵢⱼ [lacuna] the exemplary embodiment, one neuron for the real part of a brightness value Iᵢⱼ and one neuron for the imaginary part of the transformed brightness information Iᵢⱼ.

The neurons 206 in the neuron layer 205 which record the transformed brightness signal 204 produce a neuron output value 207.

A reconstructed image 209 is formed by means of the neuron output signal 207 in an image reconstruction unit 208.

According to this exemplary embodiment, the image reconstruction unit 208 has neurons which carry out a Gabor wavelet transformation.

For this purpose, the image reconstruction unit 208 has neurons which are linked to one another in accordance with a feedforward structure, and correspond to a Gabor-receptive field.

Expressed in other words, this means that the image reconstruction is carried out in accordance with the following rule:

$${\hat{I}}_{ij} = C {\sum }_{k = 0}^{K} {\sum }_{p = 0}^{P} {\sum }_{q = 0}^{Q} {\sum }_{l = 0}^{L - 1} {r}_{kpql} {G}_{kpql} ( i , j ) , \qquad ( 13 )$$

where K denotes the maximum resolution.

The density of the wavelet basis used is denoted by a constant C. Since the Gabor wavelet basic functions are not orthogonal, this rule (13) and its linear superposition do not guarantee that a minimum reconstruction error E is achieved, which is formed in accordance with the following rule:

$$E = {\sum }_{i = 1}^{n} {\sum }_{j = 1}^{n} {g}_{ij} {‖ {I}_{ij} - {\hat{I}}_{ij} ‖}^{2} \qquad ( 14 )$$

A correction for this rule (14) can be obtained by dynamic optimization of the reconstruction error E by means of a feedback link.

A feedback correction term

$${r}_{kpq1}^{corr}$$

is then formed for each neuron 206 in the neuron layer 205.

The dynamics of the recurrent neural network 200 are governed by the formation of a dynamic reconstruction error in accordance with the following rule:

$$E = {\sum }_{i = 1}^{n} {\sum }_{j = 1}^{n} {g}_{ij} ‖ {I}_{ij} - C {\sum }_{k = 0}^{K} {\sum }_{p = 0}^{P} {\sum }_{q = 0}^{Q} {\sum }_{l = 0}^{L - 1} \{ {r}_{kpq1} + {r}_{kpq1}^{corr} \} {G}_{kpq1} ( i , j ) {‖}^{2} . \qquad ( 15 )$$

The dynamic reconstruction error of the recurrent neural network 200 is minimized.

This is achieved by dynamic adaptation of the correction term

$${r}_{kpq1}^{corr}$$

in accordance with the following rule:

$$\frac{{\partial }_{kpq1}^{corr}}{\partial t} = - \frac{η}{2} \frac{\partial E}{\partial {r}_{kpq1}^{corr}} = η {\sum }_{i = 1}^{n} {\sum }_{j = 1}^{n} {g}_{ij} {E}_{ij} {G}_{kpq1} ( i , j ) = η ⟨ {G}_{kpq1} , E ⟩ , \qquad ( 16 )$$

where

$${E}_{ij} = ( {I}_{ij} - C {\sum }_{k = 0}^{K} {\sum }_{p = 0}^{P} {\sum }_{q = 0}^{Q} {\sum }_{l = 0}^{L - 1} \{ {r}_{kpq1} + {r}_{kpq1}^{corr} \} {G}_{kpq1} ( i , j ) ) \qquad ( 17 )$$

and where η denotes a change coefficient (according to the exemplary embodiment, η=0.1).

The constant C is formed in accordance with the following rule:

max(Iᵢⱼ)=max(Îᵢⱼ),

where max( ) denotes the maximum value of the respective values.

The dynamics described above can clearly be interpreted as follows.

If the reconstruction error signal E is fed back and is convoluted with the same Gabor-receptive fields (<<Gkpql, E>>, then the entire dynamic system converges to an attractor which corresponds to the minimum reconstruction error signal 214.

The reconstruction error signal 214 is formed by means of a difference unit 210. The difference unit 210 is supplied with the contrast-free brightness signal 211 and with the reconstructed brightness signal 212. Formation of the difference between the contrast-free brightness value 211 and the respective reconstructed brightness value 212 in each case results in a reconstruction error value 213 which is supplied to the receptive field, that is to say to the Gabor filter.

In a learning phase, a training method is carried out in accordance with rule (16) for each object to be determined from a set of objects which are to be determined, that is to say of objects which are to be identified, and for each local resolution, in the feature extraction unit 103 described above.

This is done by extraction of the corresponding 2D Gabor wavelet features of each object for each local resolution.

The identification unit 104 stores in its weights of the neurons the extracted feature vectors 105 for each local resolution individually.

Different feature extraction units 103 are thus trained corresponding to each local resolution for each object to be determined, as is indicated by the different feature extraction units 103 in FIG. 1.

The positions of the centers of the receptive fields are digitized and, for a local resolution of level k, result in:

cₓ=pba^{k} (18)

and

c_{y}=qba^{k}. (19)

This clearly means that wavelets which are physically located relatively close are separated by smaller steps, and wavelets that are further away are separated by larger steps.

According to this exemplary embodiment, the receptive fields for each local resolution cover the entire recording region in the same way, that is to say they always overlap in the same way.

A feature extraction unit 103 with local resolution k thus has

$${L ( \frac{n}{( b {a}^{k} )} )}^{2} \qquad ( 20 )$$

Gabor neurons.

The Gabor neurons are uniquely identified by means of the index kpql and the activation r_{kpql} which, as has been described above, is produced by the convolution of the corresponding receptive field with the brightness values Iᵢⱼ of the pixels in the detection region.

The procedure described above, by means of the feature extraction unit 103 which is preferably used and by means of the forward-directed Gabor links, quickly results in the determination of a sufficiently good set of wavelet basic functions for greatly improved coding of the brightness values, which is formed by the recurrent dynamic analysis of the reconstruction error value 213, thus resulting in a smaller number of iterations in order to determine the minimum reconstruction error value 213.

The fed back reconstruction error E is used in accordance with the exemplary embodiment in order to improve the forward-directed Gabor representation of the image 201 dynamically in the sense that the problem described above of redundancy in the description of the image information is corrected dynamically since the Gabor wavelets are not orthogonal.

The redundancy of the Gabor feature description has therefore been reduced considerably, in dynamic terms, by improving the reconstruction on the basis of the internal representation of the image information.

This structure therefore results in a nonlinear correction of the normal linear representation of a Gabor filter, thus achieving more efficient-predictive coding of the image information.

The number of iterations required in order to achieve optimum predictive coding of the image information can be reduced further by using a more than complete number of Gabor neurons for feature coding.

A basis which is thus more than complete allows a greater number of basic vectors than input signals. According to the exemplary embodiment, at least the magnitude of the number predetermined by the local resolution K is used for a feature extraction unit 103 with the local resolution K for reconstruction of the internal representation of the Gabor neurons with wavelet features corresponding to the octave.

According to the exemplary embodiment, six octaves, that is to say six feature extraction units 103 (N=6) with eight orientations (L=8), where b=1 and a=2, are used, so that, when using all the resolution levels,

$${L ( \frac{n}{( b {a}^{k} )} )}^{2} \qquad ( 20 )$$

coding Gabor neurons are used.

Since, according to the exemplary embodiment, the image contains 16,384 pixels, 174,080 coding Gabor neurons are used to form the more than complete basis.

The neurons in the neuron layer 205 will be explained in detail in the following text (see FIG. 3).

On the basis of the exemplary embodiment, it is assumed that, for each neuron 206 (with one neuron 300 being provided for a real part and one neuron 301 being provided for the imaginary part of the Gabor transformation, as has been explained above, that is to say two neurons for one “logical” neuron) with the corresponding links for the feature extraction unit 103 in each case as weighting information, which [lacuna] the description is stored by means of feature vedtors of an object for a specific local resolution and for a specific position of the object in the recording region.

The neurons 206 in the neuron layer 205 are arranged organized in columns, so that the neurons are arranged topographically.

The receptive fields of the identification neurons are set out such that only a restricted square recording region of the neuron input values around a specific center region is transmitted.

The size of the square receptive fields of the identification neurons is constant, and the identification neurons are set out such that only the signals from neurons 206 in the neuron layer 205 (which is located within the recording region of the respective identification neuron 301, 302) are considered.

In the course of the training phase, the center of the receptive field is located at the brightness center of the respective object.

Translation invariance is achieved in that, for each object which is to be learned, that is to say for each object which is to be identified in the application phase, identical identification neurons, that is to say neurons which share the same weights but have different centers, are distributed over the overall coverage area.

Rotation invariance is achieved in that, at each position, the sum of the wavelength coefficients along the different orientations are stored.

In summary, based on the exemplary embodiment, a specific number of identification neurons are provided for each object which is to be learnt for the first time during the learning phase, the weights of which identification neurons are used to store the corresponding wavelet-basing internal description of the respective object, that is to say of the feature vectors which describe the objects.

An identification neuron is produced for each local resolution, corresponding to the respective internal description based on the corresponding octave, that is to say the corresponding local resolution, and each of the identification neurons is arranged in a distributed manner for all the center positions throughout the entire recording region.

The identification neurons are linear neurons which, as the output value [lacuna] a linear correlation coefficient between its input weights and the input signal, which are formed by the neurons 206 in the neuron layer which are located in the feature extraction unit 103.

FIG. 3 shows the respective identification neurons 305, 306, 307, 308, 309, 310, 311, 312 for different objects 303, 304. Each object is clearly produced at a predetermined position, which can be predetermined freely, in the recording region at one time and during the training phase.

The weights of the identification neurons are used to store the wavelet-based information. For a given position, that is to say a center with the pixel coordinates (cₓ, c_{y}), two identification neurons are provided for each object which is to be learned, one for storing the real part of the wavelet description and one for storing the imaginary part of the internal wavelet description.

The internal description of the neurons after completion of the convergence of the recurrent dynamics, as has been described above, is stored on the basis of the following two tensors:

$${w}_{kpq} = Re ( {\sum }_{1 = 0}^{L - 1} ( {r}_{k} ( p + {c}_{x} ) ( q + {c}_{y} ) 1 + {r}_{k ( p + {c}_{x} ) ( q + {c}_{y} )}^{corr} 1 ) ) , \qquad ( 21 )$$

and

$${\tilde{w}}_{kpq} = Im ( {\sum }_{1 = 0}^{L - 1} ( {r}_{k} ( p + {c}_{x} ) ( q + {c}_{y} ) 1 + {r}_{k ( p + {c}_{x} ) ( q + {c}_{y} )}^{corr} 1 ) ) , \qquad ( 22 )$$

where Re( ) in each case denotes the real part and Imo in each case denotes the imaginary part and, for the indices p and q:

p,q∈[−R, R], (23)

where R denotes the width of the receptive field in recorded pixels.

Based on the exemplary embodiment, R=32 pixels is chosen.

During the training phase, the center (cₓ,c_{y}) is formed by the brightness center of the respective object, which is given by:

$${c}_{x} = \frac{( {\sum }_{i = 1}^{n} {I}_{ij} \cdot i )}{( {\sum }_{i = 1}^{n} {I}_{ij} )} , \qquad ( 24 )$$

and

$${c}_{y} = \frac{( {\sum }_{i = 1}^{n} {I}_{ij} \cdot j )}{( {\sum }_{i = 1}^{n} {I}_{ij} )} . \qquad ( 25 )$$

Formation of the sum over all the indices l results in a rotation-invariant description of the corresponding object.

Neurons which are activated on the basis of a stimulus at another center are formed in the same way, with the same weights being used to identify the same object at a shifted position within the recording region.

The output of an identification neuron in the course of the identification phase is given by a correlation coefficient which describes the correlation between the weights and the output of the neurons 206 in the neuron layer 205.

According to the exemplary embodiment, the output of an identification neuron in the identification unit 104 for a local resolution k, related to the real parts of the neurons 206 in the neuron layer 205 for the local resolution k and related to the center (zₓ,z_{y}) is given by:

$${o}_{k}^{( {z}_{x} , {z}_{y} )} = \frac{( {\sum }_{p = - R}^{R} {\sum }_{q = - R}^{R} ( {w}_{kpq} - ⟨ {w}_{k} ⟩ ) ( {v}_{kpq}^{( {z}_{x} , {z}_{y} )} - ⟨ {v}_{k} ⟩ ) )}{{σ}_{{w}_{k}} {σ}_{{v}_{k}}} . \qquad ( 26 )$$

The output of the corresponding identification neuron for the imaginary part is given by:

$${\tilde{o}}_{k}^{( {z}_{x} , {z}_{y} )} = \frac{( {\sum }_{p = - R}^{R} {\sum }_{q = - R}^{R} ( {\tilde{w}}_{kpq} - ⟨ {\tilde{w}}_{k} ⟩ ) ( {\tilde{v}}_{kpq}^{( {z}_{x} , {z}_{y} )} - ⟨ {\tilde{v}}_{k} ⟩ ) )}{{σ}_{{\tilde{w}}_{k}} {σ}_{{\tilde{v}}_{k}}} . \qquad ( 27 )$$

Where <a> is the mean value and ca is the standard deviation of a variable a over the recording region, that is to say over all the indices p, q.

It should be noted that, for each local resolution, the neurons are activated as a function of the recording of the same object, but also as a function of the different positions, since the same weights corresponding to the object are stored for different positions.

According to the exemplary embodiment, the centers of the identification neurons are arranged over the recording region such that they completely cover the detection region, and in each case one neuron half overlaps the recording region of a further neuron, that is to say for n=128 and R=64, nine centers are arranged at the following positions: ((32, 32) (32, 64) (32, 96) (64, 32) (64, 64) (64, 96) (96, 32) (96, 64) (96, 96)).

Thus, during the identification phase, the different identification units 104 are activated serially by the control unit 106, as will be described in the following text.

After activation of the appropriate identification unit 104, a check is carried out to determine whether a predetermined criterion is or is not satisfied, with the activation of the identification neurons with the greatest activation being determined corresponding to the octave which is greater than or equal to the present octave, that is to say by taking account only of the activated identification units 104 at the appropriate time.

Expressed in other words, a so-called winner takes all strategy is used for the decision as to which identification neuron is selected, in such a way that the selected identification neuron, which is associated with a specific center and a specific object, is analyzed by the control unit 106.

As will be explained in the following text, the control unit 106 can also decide whether the identification of the corresponding object is sufficiently accurate, or whether a more detailed analysis of the object is required by selection of a smaller, more detailed region, with higher local resolution.

If this is the situation, further neurons in the further feature extraction units 103 or identification units 104 are activated, so that the local resolution is increased.

As is illustrated in FIG. 4, the identification unit 104 forms a priority map for the recording region with the coarsest local resolution with the priority map indicating individual subregions of the image region, and with a probability being allocated to the corresponding subregions, indicating how probable it is that the object to be identified is located in that subregion (see FIG. 4).

The priority map is symbolized by 400 in FIG. 4. A subregion 401 is characterized by a center 402 of the subregion 401.

The individual iterations in which different subregions and subsubregions are selected and are investigated with a higher local resolution in each case will be explained in more detail in the following text.

According to the exemplary embodiment, a serial feedback mechanism is provided for masking the recording regions, as a result of which successive further recording units 102 and feature extraction units 103 as well as identification units 104 are activated appropriately for the respectively selected increased resolution k, that is to say the control unit 106 controls the positioning and size of the recording region in which visual information is recorded by the system and is processed further.

In a first step, the entire image 201 is processed, but with the coarsest local resolution, that is to say only the first identification unit and feature extraction unit are activated, with k=N.

Using this coarse local resolution, only the position of the object can normally be identified in practice, and a very coarse determination of the global shape of an object is established.

Depending on the respective task, the control unit stores the result of the identification unit as a priority map and one subregion of the image is selected in which, as will be described in the following text, image information is investigated.

The corresponding selection of the subregion is fed back through the same feedback links through the activated wavelet module.

The selection of the subregion, that is to say the statement as to which pixels will be investigated in more detail with increased local resolution, is carried out on the basis of the pixels which describe the object with the most recently activated local resolution.

The appropriate pixels are selected on the basis of the pixels which allow good reconstruction, that is to say reconstruction with a low reconstruction error, as well as by pixels which do not correspond to a filtered black background.

In other words, the attention mechanism is object-based in the sense that only those regions in which the object is located are analyzed further in serial form with a higher local resolution.

This means that the corresponding lower octaves are activated in serial form, but only in the selected subregion.

The attention mechanism is described mathematically by means of a matrix Gᵢⱼ, whose elements have the value “1l”? when the corresponding pixels are intended to be taken into account, and have the value “0”, when the corresponding pixel is not intended to be taken into account.

The entire image 201 is analyzed with the coarsest local resolution in the course of the object identification process (k=N), that is to say:

gᵢⱼ=1 ∀i,j. (28)

The priority map is produced and the control unit 106 decides which object will be analyzed in more detail in a further step, so that, in the course of the next-higher local resolution, the only pixels which are taken into account are those which are located in that image area, that is to say in the selected subregion.

Two further conditions are assumed on the basis of the exemplary embodiment.

The first condition is that the reconstructed image has brightness value Îᵢⱼ>0, and the second condition is that the reconstruction error is not greater than a predetermined threshold, that is to say:

gᵢⱼEᵢⱼ<α. (29)

If the control unit 106 thus decides that the object which will be analyzed in more detail at a center (cₓ, c_{y}) in the priority map, then the mask, given by the matrix Gᵢⱼ, is updated in accordance with the following rules:

$${g}_{ij}^{new} = \{ \begin{matrix}1 & \{ \begin{matrix} if ( - R + {c}_{x} ) < i < ( R + {c}_{x} ) \\ elseif ( - R + {c}_{y} ) < j < ( R + {c}_{y} ) \\ elseif {\hat{I}}_{ij} > 0 and {g}_{ij}^{old} {E}_{ij} < α\end{matrix} \\ 0 & else\end{matrix} . \qquad ( 30 )$$

In general, the attention feedback between the local resolution k and the subsequent local resolution k−1 (that is to say the increased local attention) for k>N is controlled only by the two conditions mentioned above.

A new matrix value Gᵢⱼ is therefore defined on the basis of the exemplary embodiment for the activation of the next, increased local resolution k−1, defined in accordance with the following rule:

$${g}_{ij}^{new} = \{ \begin{matrix}1 \\ 0\end{matrix} \begin{matrix}if {\hat{I}}_{ij} > 0 and {g}_{ij}^{old} {E}_{ij} < α \\ else\end{matrix} . \qquad ( 31 )$$

The profile of the various iterations of the investigation of the individual subregions and subsubregions with different local resolutions will be described in the following text for identification of one specific object.

Four types of objects are envisaged for the purposes of this example, as are shown in FIG. 5a.

A first object 501 has the global shape of an H and has as local elements object components with the shape T, for which reason the first object is annotated Ht.

The second object 502 has a global H shape and, as local object components, likewise has H-shaped components, for which reason the second object 502 is annotated Hh.

A third object 503 has a global as well as a local T-shaped structure, for which reason the third object 503 is annotated Tt.

A fourth object 504 has a global T shape and a local H shape of the, individual object components, for which reason the fourth object 504 is annotated Th.

FIG. 5b shows the identification results from an apparatus according to the invention for different local resolutions, in each case for the first object 501 (identified object with the first local resolution 510, with the second local resolution 511, with the third local resolution 512 and with the fourth local resolution 513).

FIG. 5b furthermore shows the identification results for an apparatus according to the invention for different local resolutions, in each case for the second object 502 (identified object with the first local resolution 520, with the second local resolution 521, with the third local resolution 512 and with the fourth local resolution 523).

FIG. 5b also shows the identification results for an apparatus according to the invention for different local resolutions, in each case for the third object 503 (identified object with the first local resolution 530, with the second local resolution 531, with the third local resolution 532 and with the fourth local resolution 533).

FIG. 5b also shows the identification results for an apparatus according to the invention for different local resolutions, in each case for the fourth object 504 (identified object with the first local resolution 540, with the second local resolution 541, with the third local resolution 542 and with the fourth local resolution 543).

As can be seen from FIG. 5b, with the highest local resolution, the respective object is actually identified with a very good, and at least sufficient, accuracy.

The method for determining an object in an image will be explained clearly once again with reference to FIG. 6.

In a first step (step 601), a feature extraction process is carried out with a first local resolution j=1 (step 602) for the pixels, that is to say for the brightness value of the pixels, in the recorded image.

In a further step, a first subregion Tbᵢ is formed from the image (step 603).

A probability is determined for each subregion Tbi that is formed of the objects to be determined being located in the corresponding subregion Tbi. This results in a priority map, which contains the respective associations between the probability and the subregion (step 604).

Depending on the priority map that is formed, a first subregion Tbi where i=1 is selected, and the neurons are activated such that the selected subregion is incremented by the value 1 in step 605, such that the selected subregion Tbi is investigated with an increased local resolution (steps 606, 607).

In a test step 608, a check is carried out to determine whether the object has been identified with sufficient confidence (step 608).

If this is the case, then the identified object is output as the identified object (step 609).

If this is not the case, then a check is carried out in a further test step (step 610) to determine whether a predetermined termination criterion is satisfied, according to the exemplary embodiment whether a predetermined number of iterations has been reached.

If this is the case, the method is ended (step 611).

If this is not the case, then a check is carried out in a further test step (step 612) to determine whether a further subsubregion should be selected.

If a further subsubregion which should be investigated with increased resolution should be selected, then this corresponding subsubregion is selected (step 613) and the method is continued in step 606 by incrementing the local resolution for the appropriate subsubregion.

However, if this is not the case, then a further subregion Tbi+1 is selected from the priority map (step 614), and the method is continued in a further step (step 605).

The following documents are cited in this document:

[1] A. Treisman, Perceptual Grouping and Attention in Visual Search for Features and for Objects, Journal of Experimental Psychology: Human Perception and Performance, Vol. 8, pages 194-214, 1982

[2] J. Daugman, Complete Discrete 2D-Gabor-Transforms by Neural Networks for Image Analysis and Compression, IEEE-Transactions on Acoustics, Speed and Signal Processing, Vol. 36, pages 1169-1179, 1988

[3] D. J. Heeger, Nonlinear Model of Neural Responses in Cat Visual Cortex, Computational Models of Visual Processing, Edited by M. Landy and J. A. Movshon, Cambridge, Mass., MIT Press, pages 119-133, 1991

[4] D. J. Heeger, Normalization of Cell Responses in Cat Striate Cortex, Visual Neuro Science, Vol. 9, pages 181-197, 1992

1. A method for determining an object in an image,
in which information from the image is recorded with a first local resolution,
in which a first feature extraction process is carried out for the information from the image,
in which at least one subregion in which the object could be located is selected from the image on the basis of the feature extraction process,
in which information from the selected subregion is recorded with a second local resolution, with the second local resolution being higher than the first local resolution,
in which a second feature extraction process is carried out for the information from the selected subregion,
in which a check is carried out to determine whether a predetermined criterion is satisfied,
in which the method is ended or a further subregion is selected from the image, and information from the further subregion is recorded with a second local resolution if the predetermined criterion is not satisfied,
in which information from at least one subsubregion of the selected subregion is recorded iteratively in each case with a higher local resolution, and in which a check is carried out to determine whether the information recorded with the respectively higher local resolution satisfies the predetermined criterion, until the predetermined criterion is satisfied.

2. The method as claimed in claim 1,
in which the criterion is whether the information recorded with the second local resolution is sufficient to record the information with sufficient accuracy.

3. The method as claimed in claim 1,
in which the criterion is a predetermined number of iterations.

4. The method as claimed in one of claims 1 to 3,
in which the feature extraction processes are carried out by means of a transformation with a respectively different local resolution.

5. The method as claimed in claim 4,
in which a wavelet transformation is used as the transformation.

6. The method as claimed in claim 5,
in which a two-dimensional Gabor transformation is used as the wavelet transformation.

7. The method as claimed in one of claims 4 to 6,
in which the transformation is carried out by means of a neural network.

8. The method as claimed in claim 7,
in which the transformation is carried out by means of a recurrent neural network.

9. The method as claimed in one of claims 1 to 8,
in which a number of subregions are determined in the image, in each of which there is a determined probability of that subregion containing the object to be identified,
in which the iterative method is carried out for the subregions in the sequence of correspondingly falling probability.

10. The method as claimed in one of claims 1 to 9,
in which the shape of a selected subregion corresponds essentially to the shape of the object to be identified.

11. A method for training an arrangement with a learning capability, which arrangement is intended to be used for determining an object in an image,
in which an image which contains an object to be identified is recorded, with the position of the object to be identified in the image and the object being predetermined,
in which a number of feature extraction processes are carried out for the object, in each case with a different local resolution,
in which the arrangement is in each case trained for a local resolution using the extracted features.

12. The method as claimed in claim 11,
in which at least one neural network is used as the arrangement.

13. The method as claimed in claim 12,
in which the neurons of the neural network are arranged topographically.

14. An arrangement for determining an object in an image, having a processor which is set up such that the following method steps can be carried out:
information from the image is recorded with a first local resolution,
a first feature extraction process is carried out for the information from the image,
at least one subregion in which the object could be located is selected from the image on the basis of the feature extraction process,
information from the selected subregion is recorded with a second local resolution, with the second local resolution being higher than the first local resolution,
a second feature extraction process is carried out for the information from the selected subregion,
a check is carried out to determine whether a predetermined criterion is satisfied,
the method is ended or a further subregion is selected from the image, and information from the further subregion is recorded with a second local resolution if the predetermined criterion is not satisfied,
information from at least one subsubregion of the selected subregion is recorded iteratively in each case with a higher local resolution, and a check is carried out to determine whether the information recorded with the respectively higher local resolution satisfies the predetermined criterion, until the predetermined criterion is satisfied.

15. An arrangement for determining an object in an image, having
a recording unit for recording information from the image using a number of different local resolutions,
a feature extraction unit for extracting features for the information recorded by the recording unit,
a selection unit for selecting at least one subregion from the image, in which the object could be located, on the basis of the features extracted by the feature extraction unit,
a control unit for controlling the recording unit, which control unit is set up such that information from the selected subregion is recorded using a second local resolution, with the second local resolution being higher than the first local resolution,
a decision unit, in which a check is carried out to determine whether a predetermined criterion relating to the respectively extracted features is satisfied,
with the control unit furthermore being set up
such that:
the method is ended or a further subregion is selected from the image, and information from the further subregion is recorded with a second local resolution if the predetermined criterion is not satisfied,
information from at least one subsubregion of the selected subregion is recorded iteratively in each case with a higher local resolution, and that a check is carried out to determine whether the information recorded with the respectively higher local resolution satisfies the predetermined criterion, until the predetermined criterion is satisfied.

16. A computer legible storage medium, in which a computer program for determining an object in an image is stored, which computer program has the following method steps when it is carried out by a processor:
information from the image is recorded with a first local resolution,
a first feature extraction process is carried out for the information from the image,
at least one subregion in which the object could be located is selected from the image on the basis of the feature extraction process,
information from the selected subregion is recorded with a second local resolution, with the second local resolution being higher than the first local resolution,
a second feature extraction process is carried out for the information from the selected subregion,
a check is carried out to determine whether a predetermined criterion is satisfied,
the method is ended or a further subregion is selected from the image, and information from the further subregion is recorded with a second local resolution if the predetermined criterion is not satisfied,
information from at least one subsubregion of the selected subregion is recorded iteratively in each case with a higher local resolution, and a check is carried out to determine whether the information recorded with the respectively higher local resolution satisfies the predetermined criterion, until the predetermined criterion is satisfied.

17. A computer program element for determining an object in an image, which has the following method steps when it is carried out by a processor:
information from the image is recorded with a first local resolution,
a first feature extraction process is carried out for the information from the image,
at least one subregion in which the object could be located is selected from the image on the basis of the feature extraction process,
information from the selected subregion is recorded with a second local resolution, with the second local resolution being higher than the first local resolution,
a second feature extraction process is carried out for the information from the selected subregion,
a check is carried out to determine whether a predetermined criterion is satisfied,
the method is ended or a further subregion is selected from the image, and information from the further subregion is recorded with a second local resolution if the predetermined criterion is not satisfied,
information from at least one subsubregion of the selected subregion is recorded iteratively in each case with a higher local resolution, and a check is carried out to determine whether the information recorded with the respectively higher local resolution satisfies the predetermined criterion, until the predetermined criterion is satisfied.
